(19) United States
(12) Patent Application Publication
(10) Pub. No.: US 2008/0182943 A1
(43) Pub. Date: Jul. 31, 2008

(54) ONE-COMPONENT CURABLE ELECTRICAL INSULATION COATING

(75) Inventors: Ronald W. Goetter, Maryville, IL (US); Max F. Vandersall, University City, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The P.D. George Company, St. Louis, MO (US)

(21) Appl. No.: 11/668,288

(22) Filed: Jan. 29, 2007

(51) Int. Cl. C08G 63/02; C08G 65/04

(52) U.S. Cl. 525/409; 525/418

(57) ABSTRACT

A one-component curable insulating coating composition comprises encapsulated catalysts and encapsulated curing agents mixed with an unsaturated resin. The encapsulated catalyst and/or curing agent is prevented from chemically contacting the resin until a cure temperature is achieved. The one-component coating composition has a shelf life that is equal to or greater than 6 months and a cure temperature and/or cure time that is lower than the cure temperature and/or cure time normally associated with currently available multi-component coating compositions.

### CROSS REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

This invention relates to insulation coatings used in electromagnetic devices or equipment such as motors and generators; and more particularly to one component coating systems comprised of encapsulated catalysts and/or curing agents and a resin. The coating system provides the longer shelf life associated with currently available one-component coating systems and the lower temperature/time cure schedules of the currently available multi-component systems.

Forms of encapsulation have been commercially used in areas such as the production of food additives, personal care products, adhesives, and inks and toners. See, for example, Patent Nos. or Published Application Nos. U.S. Pat. No. 6,855,194, U.S. Pat. No. 6,841,181, U.S. Pat. No. 6,839,158, U.S. Pat. No. 5,607,708, U.S. Pat. No. 5,385,744, U.S. Pat. No. 5,234,711, U.S. Pat. No. 5,002,785, U.S. Pat. No. 4,929,447, and US 2003/0225185. The encapsulation technology employed in these areas is based upon factors such as cure time and curing temperature, as well as the catalyst and/or curing agent used. In addition matters such as the choice of materials used to make the shell of a capsule, crosslink density of the shell material, etc. are also considered in the encapsulation technology.

Organic resin compositions are used as coatings in electromagnetic devices such as electrical motors and generators because of their mechanical and electrical properties, and the environmental protection they impart to these devices. The coatings provide enhanced mechanical strength and electrical insulation capability; while, the environmental protection allows for longer-term durability of the devices. Overall quality of the devices is also improved. Current compositions are either a one-component composition where a catalyst and/or a curing agent is mixed with a resin and then supplied to an end user; or a multi-component composition in which the end user adds a catalyst and/or curing agent to the resin supplied to him to initiate a polymerization reaction.

One-component compositions have a better shelf life than multi-component ones, but they require a higher temperature and/or a longer time to properly cure into a finished film. Multi-component systems cure more quickly and at a lower temperature than one-component system, but do not have a desirable, long term shelf life.

The addition and mixing of a catalyst/curing agent to a composition, at the end-user's site, as is required when multi-component systems are used, adds time to the preparation of the final product (the film) and requires the end user to have appropriate resources to complete the process. In addition, completing the process at the end user's site creates both safety and handling concerns in working with the necessary materials. Another concern about the final product arises because the amount or type of catalyst/curing agent that is added to the resin at one end-user's facility may well differ from that added either at another end user's facility, or at the facility where the composition was initially formulated, were the process to be completed there.

### BRIEF SUMMARY OF THE DISCLOSURE

Briefly stated, a one-component insulation coating system includes encapsulated catalysts and/or curing agents mixed into a curable resin, such as an unsaturated polyester resin. The catalyst/curing agent can, for example, be peroxide. Because the catalyst and/or curing agent is encapsulated, the catalyst and/or curing agent does not come into contact with the resin until a desired curing temperature is achieved. At the curing temperature, the encapsulation shell breaks allowing the catalyst/curing agent to come into contact with the resin, and hence, for the curing reaction to begin. The resulting one-component coating system has a shelf life which is longer than the shelf life normally achieved with currently available one-component systems. Additionally, the resulting one-component system can provide for the lower temperature/time cure schedules that are normally associated with currently available multi-component systems. Thus, our one-component coating system has the longer shelf life of currently available one-component systems and/or the lower cure temperature of currently available multi-component systems.

Use of encapsulation technology in insulative coatings has a number of advantages. One is production of a more consistent final product regardless of the where the coating is produced. Another advantage is the savings realized in capital equipment costs which is achieved by reducing or eliminating the need for complex equipment usually required for mixing multi-component compositions.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

A coating composition prepared in accordance with the present invention involves the use of encapsulation technology for electrical insulation applications. In particular, the coating system incorporates an activator in the form of a catalyst and/or curing agent into a one-component composition, without allowing the catalyst or curing agent used to come into contact with the resin used in the composition until a specific curing temperature is achieved. When the coating composition is raised to the curing temperature, the encapsulation shell begins to break down allowing the catalyst and/or curing agent to come into contact with the resin, thereby initiating the curing reaction. Advantageously, our coating composition has a longer shelf life than would otherwise be expected of currently available one-component composition and could have a lower temperature/time cure schedule than otherwise would be expected for currently available multi-component compositions. Our new one-component coating composition eliminates a number of the problems associated with the currently available coating compositions, while providing improved compositions that retain all of the desired properties found in current compositions. In this latter regard, the uniqueness of the coating composition is in the application of encapsulation technology to the electrical insulation industry and the ability to use the technology with current curing systems. These curing systems include, but are not limited to, gas-fired ovens, infrared radiation heating, resistance heating, ultraviolet energy cure, ultrasound, etc. Application techniques include, but are not limited to, trickle, gravity dip, vacuum impregnation, vacuum pressure impregnation (VPI), roll through, spray, etc.

Various chemistries (i.e., resins) can be used in the coating composition. These include, for example, reactive polyester, epoxy, urethane, and epoxy/polyester copolymers, etc. However, those skilled in the art will understand that other curable resins can also be used to produce an electrical insulation in a process requiring a catalyst or curing agent to initiate a reaction that leads to film formation and cure. Examples of catalysts and curing agents that can be used include, but are not limited to, peroxides such as cumene hydroperoxide, tert-butyl perbenzoate; Lewis acid catalysts such as boron trifluoride and trichloride complexes; anhydrides such as dodecenylsuccinic anhydride, methyl-tetrahydrophthalic anhydride, nadic methyl anhydride, etc.; and, isocyanates such as methyldiphenyl isocyanates (MDI), toluene diisocyanate (TDI) and its polymers; as well as various aliphatic isocyanates. It is further possible to encapsulate metallic promoters commonly used in the industry; including, but not limited to metal salts, such as salts of cobalt, manganese, calcium, copper, zirconium, aluminum, tin, and mercury, etc.

In one aspect of the invention, the coating composition is prepared by mixing encapsulated peroxides with an unsaturated resin. When the cure temperature is reached, the encapsulation shell breaks down and free radical curing of the resin is initiated. As shown in Free-Radical Frontal Polymerization with a Microencapsulated Initiator published in Macromolecules 2004, 37, 6670-6672 by Brian McFarland, Sam Popwell, and John A. Pojman (which is incorporated herein by reference), while working with 1,6-Hexanediol diacrylate when a tube containing unencapsulated cumene hydroperoxide (CHP) and a small amount of accelerator spontaneously polymerized after a storage time of 1.5 hours. The tube containing encapsulated CHP and accelerator was stable for a period of 5 days. We have seen that when 1% active CHP is stored in an unsaturated polyester, gellation occurs in 12 to 13 days but when 1% active CHP is encapsulated and stored in the same unsaturated polyester, gellation occurred in 24 to 27 days. We have found that the coating composition has an increased the shelf life without a negative impact on the cure response of the coating composition.

An advantage of the coating composition is that it addresses end user concerns regarding the handling of various catalysts and curing agents by allowing a one-component composition to be supplied to the end user that is ready for use as it received from the supplier. This solves a number of health and safety issues, and reduces or eliminates the possibility of weighing and mixing errors that create quality issues in the final product. It further reduces equipment costs since multi-component mixing equipment is now not required.

### EXAMPLES OF THE INVENTION

Those skilled in the art of encapsulation technology understand that there are many synthesis methods that can be used to produce an encapsulated product useful with electromagnetic equipment.

An encapsulated peroxide (cumene hydroperoxide) is made using interfacial polymerization methodology as taught by Pojman and McFarland in Preparation and Analysis of Peroxide Microcapsules, Polymer Preprints (American Chemical Society, Division of Polymer Chemistry) (2004), 45(1), 1-2, which is incorporated herein by reference. The encapsulated catalyst is used in standard unsaturated polyester resin compositions and compared to the same resin catalyzed by peroxides such as dicumyl peroxide, cumene hydroperoxide, and/or tert-butylperbenzoate.

TABLE 1

| | Standard | System I | System II |
|---|---|---|---|
| Unsaturated Polyester Resin, pbw | 100 | 100 | 100 |
| Components | 1 or 2 | 1 | 1 |
| Dicumyl Peroxide, pbw | 1.0 | | |
| Encapsulated Dicumyl Peroxide, pbw | | 1.2 | 3.9 |

TABLE 2

| | Standard | System III | System IV |
|---|---|---|---|
| Unsaturated Polyester Resin, pbw | 100 | 100 | 100 |
| Components | 1 or 2 | 1 | 1 |
| Cumene hydroperoxide, pbw | 1.0 | | |
| Encapsulated Cumene hydroperoxide, | | 1.6 | 3.0 |
| pbw | | | |

TABLE 3

| | Standard | System V | System VI |
|---|---|---|---|
| Unsaturated Polyester Resin, pbw | 100 | 100 | 100 |
| Components | 1 or 2 | 1 | 1 |
| Tert Butylperbanzoate, pbw | 2.0 | | |
| Encapsulated Tert Butylperbanzoate, | | 2.2 | 6.6 |
| pbw | | | |

In the standard (i.e., currently available) coating systems, 1 to 2 parts by weight (pbw) peroxide is mixed 100 pbw unsaturated polyester resin. The standard coating system can be provided as either a one-component system (wherein the peroxide is pre-mixed with the resin); or a two-component system (wherein the peroxide is provided separately from the resin, and the two components are mixed together on site). The coatings made in accordance with the present invention are listed as Systems I-VI in the tables above. In the coating of System I, 1.2 pbw encapsulated peroxide is mixed with 100 pbw unsaturated polyester resin; in the coating of System II, 3.9 pbw encapsulated peroxide is mixed with 100 pbw unsaturated polyester resin; in the coatings of Systems III and IV, 1.6 and 3.0 pbw, respectively, of encapsulated cumene hydroperoxide are mixed with 100 pbw unsaturated polyester resin; and in the coatings of Systems V and VI, 2.2 and 6.6 pbw, respectively, of encapsulated tert butylperbanzoate are mixed with 100 pbw unsaturated polyester resin.

The same encapsulation methodology is also used to make core/shell materials with the core being any of the catalysts, curing agents, or metallic promoters listed above.

Results of the Example Formulations:

The formulations were tested using a number of physical and analytical tests to compare performance of standard systems (i.e., currently available one- and two-component systems) and the System I and System II coating compositions disclosed above. The tests measured reaction initiation times and temperatures, viscosity, gel times, bond strength, glass transition and stability.

TABLE 4

| | Standard | | |
|---|---|---|---|
| | One-Component | | |
| | Dicumyl | | |
| | Peroxide | | |
| | Coating | | |
| | Composition | System I | System II |
| Viscosity (20 Rpm's @ | 250 | 300 | 300 |
| 77° F.) (cP) | | | |
| Sunshine Gel @ 100° C. | 7.2 | 5.5 | 5.4 |
| (min) | | | |
| Sunshine Gel @ 125° C. | 2.7 | 2.7 | 2.9 |
| (min) | | | |
| Helical Coil Bond Strength | 38.3 | 36.6 | 31.1 |
| @ 25° C.(lbs) | | | |
| Helical Coil Bond Strength | 22.8 | 25.6 | 18.3 |
| @ 150° C. (lbs) | | | |
| Glass Transition | 154 | 145 | 145 |
| Temperature (° C.) | | | |

TABLE 5

| | Standard | | |
|---|---|---|---|
| | One-Component | | |
| | Cumene | | |
| | Hydroperoxide | | |
| | Coating Composition | System III | System IV |
| Viscosity (20 rpm, | 250 | 300 | 300 |
| 25° C., cP) | | | |
| Sunshine Gel | 6.9 | 8 | 8 |
| (100° C., min.) | | | |
| Sunshine Gel | 3.1 | 3.7 | 3.5 |
| (125° C., min.) | | | |
| Helical Coil Bond | 27.6 | 24.6 | 25.7 |
| Strength (25° C., lbs) | | | |

TABLE 6

| | Standard | | |
|---|---|---|---|
| | One-Component | | |
| | Tert | | |
| | Butylperbenzoate | | |
| | Coating Composition | System V | System VI |
| Viscosity (20 rpm, | 250 | 300 | 300 |
| 25° C., cP) | | | |
| Sunshine Gel | 8.2 | 6.9 | 6.5 |
| (100° C., min.) | | | |
| Sunshine Gel | 2.7 | 2.9 | 2.7 |
| (125° C., min) | | | |
| Helical Coil Bond | 41.7 | 45.1 | 49.6 |
| Strength (25° C., lbs) | | | |

As can be seen from the tables above, the System I, II, V and VI coating compositions have faster cure times than their corresponding standard one-component coating compositions at a cure temperature of 100° C. The System III and IV compositions had cure times that were slightly slower than their corresponding standard one-component coating composition. However, the cure time between the standard compositions and the compositions of Systems I-VI are approximately the same at a cure temperature of 125° C.

Some of the benefits of the coating composition include:
The coating composition provides for the use of encapsulation technology for a number of chemistries and curing mechanisms used in the electrical insulation industry.
The coating composition uses a core/shell encapsulation technique that is not used in the electrical insulation industry currently.

As various changes could be made in the above constructions and compositions without departing from the scope of the invention, it is intended that all matter contained in the above description shall be interpreted as illustrative and not in a limiting sense. For example, different encapsulation technologies can be used. Different catalysts, curing agents or metal promoters can be used. Different resins can be used. These examples are merely illustrative.

Having thus described the invention, what is claimed and desired to be secured by Letters Patent is:

1. A curable insulating coating composition comprising an unsaturated polyester resin, epoxy or polyol and an encapsulated activator; said activator being chosen from the group consisting of an encapsulated curing agent, an encapsulated catalyst and combinations thereof, wherein said resin and encapsulated activator are mixed together to form a one component system in which said encapsulated activator is prevented from reacting with said resin until the composition is exposed to a desired cure temperature.

2. The curable coating composition of claim 1 wherein the curing agent is a peroxide and/or a metallic promoter.

3. The curable coating composition of claim 2 wherein the peroxide is selected from the group consisting of cumene hydroperoxide, tert-butyl perbenzoate, dicumyl peroxide, peroxides used in free radical reactions, and combinations thereof.

4. The curable coating composition of claim 2 wherein the metallic promoter is a metal salt.

5. The curable coating of claim 4 wherein the metal salt is chosen from the salts of cobalt, manganese, calcium, copper, zirconium, aluminum, tin, mercury, and combinations thereof.

6. The curable coating composition of claim 1 wherein the catalyst is chosen from the group consisting of Lewis acid catalysts, anhydrides, isocyanates, peroxides and combinations thereof.

7. The curable coating composition of claim 6 wherein the Lewis acid catalyst is chosen from the group consisting of such boron trifluoride, trichloride complexes and combinations thereof.

8. The curable coating composition of claim 6 wherein the anhydride is chosen from the group consisting of such as dodecenylsuccinic anhydride, methyltetrahydrophthalic anhydride, nadic methyl anhydride, and combinations thereof.

9. The curable coating composition of claim 6 wherein the isocyanate is chosen from the group consisting of methyldiphenyl isocyanates (MDI), toluene diisocyanate (TDI) and its polymers, aliphatic isocyanates, and combinations thereof.

10. The curable insulating coating of claim 1 wherein said coating composition has a shelf life equal to or greater than about 6 months.

11. The curable insulating coating composition of claim 1 wherein said coating composition has a sunshine gel temperature at 100° C. of about 5 to about 8 minutes.

12. The curable insulating coating composition of claim 1 wherein said coating composition has a helical coil bond strength of about 24 lbs to about 50 lbs.

13. The curable insulating coating composition of claim 1 wherein said coating composition has a glass transition temperature of about 145° C.

14. The curable insulating coating composition of claim 1 wherein said coating composition comprises about 100 pbw resin combined with about 1 to about 7 pbw encapsulated peroxide.

15. A method of producing a one-component curable insulating coating composition comprising providing an encapsulated activator and mixing the encapsulated activator with a curable resin to form a substantially homogeneous mixture; said encapsulated activator being chosen from the group consisting of an encapsulated curing agent, an encapsulated catalyst, and combinations thereof.

16. The method of claim 15 wherein the resin is an unsaturated polyester resin.

17. The method of claim 15 wherein the curing agent is a peroxide and/or a metallic promoter.

18. The method of claim 17 wherein the peroxide is selected from the group consisting of cumene hydroperoxide, tert-butyl perbenzoate, dicumyl peroxide, peroxides used in free radical reactions and combinations thereof.

19. The method of claim 17 wherein the metallic promoter is a metal salt.

20. The method of claim 19 wherein the metal salt is chosen from the salts of cobalt, manganese, calcium, copper, zirconium, aluminum, tin, mercury, and combinations thereof.

21. The method of claim 15 wherein the catalyst is chosen from the group consisting of Lewis acid catalysts, anhydrides, isocyanates.

22. The method of claim 21 wherein the Lewis acid catalyst is chosen from the group consisting of such boron trifluoride, trichloride complexes and combinations thereof.

23. The method of claim 21 where the resin is an epoxy or a polyol.

24. The method of claim 21 wherein the anhydride is chosen from the group consisting of such as dodecenylsuccinic anhydride, methyl-tetrahydrophthalic anhydride, nadic methyl anhydride, and combinations thereof.

25. The method of claim 21 wherein the isocyanate is chosen from the group consisting of methyldiphenyl isocyanates (MDI), toluene diisocyanate (TDI) and its polymers, aliphatic isocyanates, and combinations thereof.

26. A method of producing a one-component curable insulating coating composition consisting of mixing encapsulated peroxide with an unsaturated polyester resin.

27. The method of claim 26 wherein said mixing step comprises mixing together about 100 pbw resin, about 1 to about 7 pbw encapsulated peroxide.

28. A curable insulating coating composition consisting of an unsaturated polyester resin and an encapsulated activator; said activator being chosen from the group consisting of an encapsulated curing agent, an encapsulated catalyst and combinations thereof, wherein said resin and encapsulated activator are mixed together to form a substantially homogeneous mixture in which said encapsulated activator is generally prevented from reacting with said resin until the composition is exposed to a desired cure temperature.
